(19) United States
(12) Patent Application Publication
(10) Pub. No.: US 2025/0236359 A1
(43) Pub. Date: Jul. 24, 2025

(54) FLEXIBLE RETRACTABLE MOORING SYSTEM SUITABLE FOR MEDIUM AND SHALLOW WATER OPERATION

(71) Applicant: JIANGSU UNIVERSITY OF SCIENCE AND TECHNOLOGY, Jiangsu (CN)

(72) Inventors: Sheng Xu, Jiangsu (CN); Xin Chen, Jiangsu (CN); Kun Ju, Jiangsu (CN)

(73) Assignee: JIANGSU UNIVERSITY OF SCIENCE AND TECHNOLOGY, Jiangsu (CN)

(21) Appl. No.: 18/660,124

(22) Filed: May 9, 2024

(30) Foreign Application Priority Data
Jan. 22, 2024 (CN) 202410087452.1

(51) Int. Cl. B63B 21/50; B63B 22/02; B63B 35/44

(52) U.S. Cl. CPC B63B 21/50; B63B 22/02; B63B 35/44; B63B 2021/505; B63B 2035/4466

(57) ABSTRACT

A flexible retractable mooring system suitable for medium and shallow water operation, including first power generation devices, a second power generation device, and anchors; where the first power generation devices and the second power generation device are all connected to an offshore platform through mooring cables, and the first power generation devices are further connected to the anchors through anchor chains; the second power generation device is located directly below the offshore platform; and when the mooring system is operating, the mooring cables and the anchor chains are all in a tension state, and the first power generation devices and the second power generation device generate power by making use of tension of the mooring cables.

### CROSS-REFERENCE TO RELATED APPLICATION

This application claims the priority benefit of China application serial no. 202410087452.1, filed on Jan. 22, 2024. The entirety of the above-mentioned patent application is hereby incorporated by reference herein and made a part of this specification.

### BACKGROUND

### Technical Field

The present disclosure relates to the technical field of offshore mooring systems, and particularly relates to a flexible retractable mooring system suitable for medium and shallow water operation.

### Description of Related Art

With the reduction of available space on land and the development of green energy, the potential for development of resources available at sea is increasing. The development of resources at sea is inseparable from the construction of offshore platforms, and constructing offshore platforms with abundant functions and high stability is a first step to obtain the resources at sea. As an important constitute of a floating system, a mooring system is mainly used for restricting movements of floating structures within a certain range, ensuring the safe operation of floating platforms. Mooring systems can be divided into catenary, taut, and semi-taut mooring systems according to shape of mooring cables thereof. Restoring force of a catenary mooring system is provided by a weight of a sag bend, while restoring force of a taut mooring system or a semi-taut mooring system is provided by an axial cable thereof.

The continental shelf in the sea of China extends is long in distance, with coastal waters generally not exceeding 60 meters in depth. In contrast to deep-sea floating platforms, floating wave power generation devices and floating wind turbines operate in shallow waters. In a shallow water environment, the catenary effect of the catenary mooring system is greatly reduced due to a limited water depth, resulting in a significant decrease in mooring performance, which means that a catenary mooring cable in the shallow waters needs an extremely long and heavy anchor chains to provide sufficient restoring performance and ensure sufficient mooring strength. Since a length of the sag bend is limited, most of the anchor chains lie on a seabed, which poses great challenges for maintenance of the mooring system. In addition, the extensive use of the anchor chains not only increases the budget, but also occupies a huge seabed area, potentially interfering with other marine activities. Unlike the operation of floating offshore platforms, most floating wave power generation devices need sufficiently flexible mooring systems to allow maximum movements in marine environments. Due to excessive stiffness, the taut mooring systems may interfere with wave power generation operations, and they are thus not preferred choice for most floating wave power generation devices.

Therefore, the existing mooring systems are prone to mooring impact load when operating in the shallow waters, posing great safety risks to the mooring systems. Therefore, the existing mooring systems are inapplicable in the shallow waters.

### SUMMARY

An objective of the present disclosure: In order to solve the above defects, the present disclosure provides a flexible retractable mooring system suitable for medium and shallow water operation.

Technical solutions: In order to solve the above problems, the present disclosure provides a flexible retractable mooring system suitable for medium and shallow water operation, including first power generation devices, a second power generation device, and anchors; where the first power generation devices and the second power generation device are all connected to an offshore platform through mooring cables, and the first power generation devices are further connected to the anchors through anchor chains; the second power generation device is located directly below the offshore platform, and the anchors are located outside the offshore platform to fix a floating range of the offshore platform; and when the mooring system is operating, the mooring cables and the anchor chains are all in a tension state, and the first power generation devices and the second power generation device generate power by making use of tension of the mooring cables and the anchor chains.

Further, the first power generation devices each includes a housing, a rotating shaft located inside the housing, and a first reset mechanism; where the first reset mechanism is mounted on a top of the housing, a roller for winding round one mooring cable is disposed below the first reset mechanism, a magnet is disposed below the roller, and coils are disposed at outer sides of the magnet; the first reset mechanism, the roller, and the magnet are all fixedly connected to the rotating shaft; internal tension of the mooring cable pulls the roller to rotate, the rotating shaft, the first reset mechanism and the magnet are then driven to rotate, a magnetic field around the magnet accordingly changes, and the coils cut magnetic induction lines to generate power; and when the internal tension of the mooring cable disappears, the first reset mechanism drives the first power generation devices to return to their respective initial positions.

Further, an interior of the first power generation device is divided into an upper cavity and a lower cavity through a partition plate, the first reset mechanism and the roller are mounted inside the upper cavity, the magnet and the coils are mounted inside the lower cavity, and the rotating shaft passes through the partition plate and is mounted on an axis of one first power generation device.

Further, the first reset mechanism includes a volute spring, and a driven shaft located at a center of the volute spring, and the driven shaft is fixedly connected to the rotating shaft; and a connecting member is disposed at an outer ring port of the volute spring, and the volute spring is mounted on the top of the housing through the connecting member.

Further, the connecting member, the volute spring and the housing are all in welding connection.

Further, the mooring cables are made from flexible material.

Further, an opening through which the mooring cable passes, and a first shackle for connecting one anchor chain, are formed on an outer wall of the housing.

Further, the second power generation device includes a base, a second reset mechanism mounted on the base, a connecting plate connected to the second reset mechanism, a main shaft rod and hydraulic rods mounted on the connecting plate, and hydraulic power generation devices are disposed on the hydraulic rods; the main shaft rod is connected to the mooring cable, when the tension of the mooring cable pulls the main shaft rod to move upwards, the main shaft rod drives the connecting plate and the hydraulic rods to move upwards, the hydraulic rods provide upward pressure for the hydraulic power generation devices to generate power; and when the tension of the mooring cable disappears, the second reset mechanism drives the second power generation device to return to its initial position.

Further, the second reset mechanism includes a plurality of return springs.

Further, a second shackle for being connected to the mooring cable is disposed on a top of the main shaft rod.

Beneficial effects: Compared with the prior art, the present disclosure has the following significant advantages: (1) the present disclosure enables the offshore platform to operate stably under shallow water conditions through the cooperation of the first power generation devices, the second power generation device, the anchors, the mooring cables and the anchor chains; (2) the floating of the offshore platform is used to cause the mooring cables to generate internal tension, and the first power generation device and the second power generation device are used for power generation, such that marine energy is effectively utilized; (3) the flexible retractable mooring cable is adopted to avoid breakage due to excessive internal tension of the mooring cable, and the service life of the mooring system is prolonged; and (4) the second power generation device is not only used for power generation, but also plays a role similar to an anchor, such that the stability of the offshore platform is further improved.

### BRIEF DESCRIPTION OF THE DRAWINGS

FIG. 1 is an overall structural schematic diagram of a mooring system according to the present disclosure.

FIG. 2 is a schematic diagram of an external structure of a first power generation device according to the present disclosure.

FIG. 3 is a cross-sectional view of an internal structure of a first power generation device according to the present disclosure.

FIG. 4 is a structural schematic diagram of a first reset mechanism according to the present disclosure.

FIG. 5 is an overall structural schematic diagram of a second power generation device according to the present disclosure.

### DESCRIPTION OF THE EMBODIMENTS

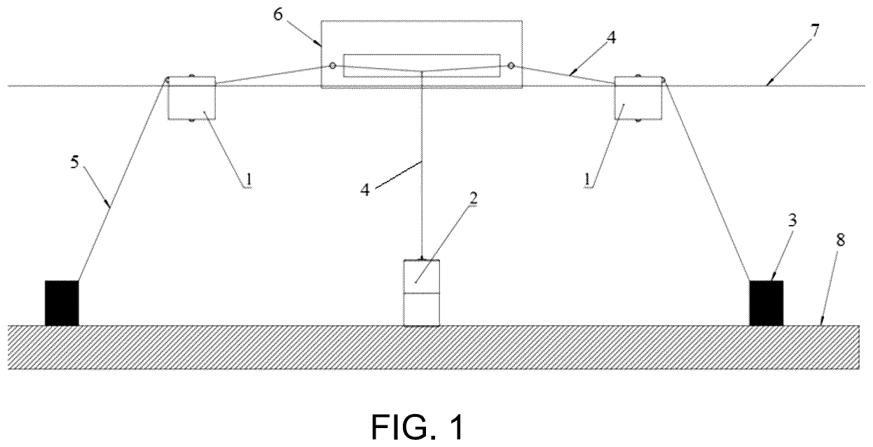

As shown in FIG. 1, a flexible retractable mooring system suitable for medium and shallow water operation provided in this embodiment includes a plurality of first power generation devices 1, a second power generation device 2, and anchors 3 with a number equaling to that of the first power generation devices 1. The first power generation devices 1 and the second power generation device 2 are all connected to an offshore platform 6 through mooring cables 4, and the first power generation devices 1 are further connected to the anchors 3 through anchor chains 5, and the mooring cables 4 and the anchor chains 5 are all in a tension state. The power generation devices 1 are used as the mooring cables 4 to realize flexible retractable functions. When mooring tension becomes larger, the mooring cables automatically become prolong, and when the mooring tension becomes smaller, the mooring cables automatically become shorten, such that the mooring tension is maintained within a predetermined range to avoid the formation of mooring impact loads, greatly enhancing the mooring safety. The anchors 3 and the second power generation device 2 are located at a water bottom 8, the second power generation device 2 is located directly below the offshore platform 6, the anchors 3 are used for fixing the mooring system, the first power generation devices 1 float on a water surface 7, one side of the first power generation device is immersed in water, and the other side thereof is exposed out of the water surface.

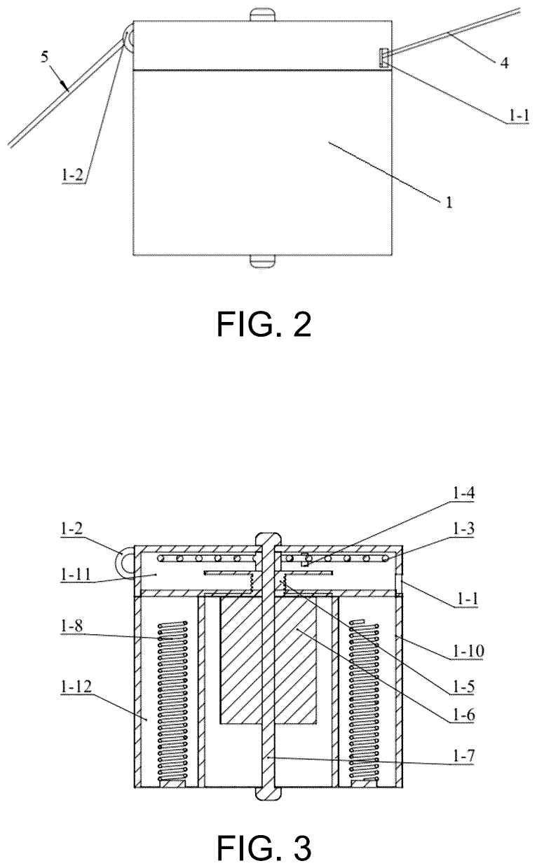

As shown in FIGS. 2 and 3, the first power generation devices 1 each includes a housing 1-10, and upper and lower cavities therein. An interior of the first power generation device 1 is divided into an upper cavity 1-11 and a lower cavity 1-12 through a partition plate. An opening 1-1 through which the mooring cable 4 passes, and a first shackle 1-2 for connecting one anchor chain 5, are formed on an outer wall of the housing 1-10.

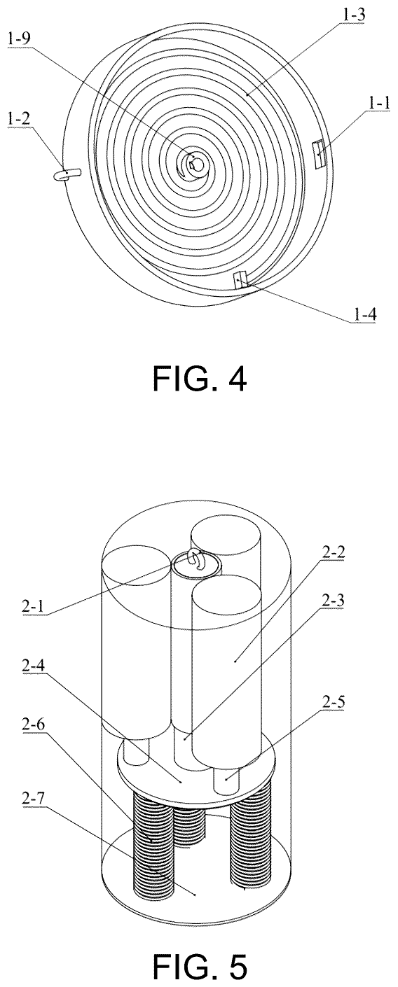

As shown in FIG. 4, the first reset mechanism includes a volute spring 1-3, a driven shaft 1-9 located at a center of the volute spring 1-3, and a connecting member 1-4 for fixing the volute spring 1-3, all of which are disposed inside the upper cavity 1-11 of the first power generation device 1. A slotted opening is formed inside the driven shaft 1-9, and a rivet is mounted in the slotted opening to firmly connect the driven shaft with a rotating shaft 1-7. The connecting member 1-4 is connected to an outer ring port of the volute spring 1-3 by welding, and the connecting member 1-4 is welded to the top surface of the housing 1-10, such that the volute spring 1-3 is fixedly mounted at a top of the first power generation device. Further, a roller 1-5 is disposed inside the upper cavity 1-11 of the first power generation device 1, the roller is mounted directly below the first reset mechanism and is fixedly connected to a slotted opening, and the mooring cable 4 is wound around the roller 1-5. The rotating shaft 1-7 passes through the partition plate, and is mounted on an axis of one first power generation device 1, and the first reset mechanism, the roller 1-5, and the magnet 1-6 are all fixedly connected to the rotating shaft 1-7.

A magnet 1-6, and coils 1-8 located on outer sides of the magnet 1-6, are disposed inside the lower cavity 1-12 of the first power generation device 1.

The power generation principle of the first power generation device 1 is as follows: the floating of the offshore platform 6 causes the mooring cable 4 wound around the roller 1-5 to generate tension and drive the roller 1-5 to rotate, the roller 1-5 drives the rotating shaft 1-7 and the magnet 1-6, and at the same time, the volute spring 1-3 inside the first reset mechanism is continuously tightened, a magnetic field around the magnet 1-6 then changes, and the coil 1-8 cuts magnetic induction lines to generate power. When the tension of the mooring cable 4 disappears, the volute spring 1-3 drives the rotating shaft 1-7 and the magnet 1-6 to rotate in an opposite direction and restore to their original positions, the magnetic field around the magnet 1-6 also changes, and the coil 1-8 cuts the magnetic induction lines again to generate power. The power generation efficiency is improved by continuously generating power in a reset process of tension generation and disappearance of the mooring cable 4.

As shown in FIG. 5, the second power generation device 2 includes a base 2-7, three return springs 2-6 mounted on the base 2-7, a connecting plate 2-4 connected to the return springs 2-6, a main shaft rod 2-3 and hydraulic rods 2-5 mounted on the connecting plate 2-4, where hydraulic power generation devices 2-2 are disposed on the hydraulic rods 2-5. A second shackle 2-1 for being connected to the mooring cable 4 is disposed on a top of the main shaft rod 2-3, and the mooring cable 4 is connected to the second shackle 2-1. The offshore platform 6 floats up and down to cause the mooring cable 4 to generate internal tension. When the tension of the mooring cable 4 pulls the main shaft rod 2-3 to move upwards, the main shaft rod 2-3 drives the connecting plate 2-4 and the hydraulic rods 2-5 to move upwards, the hydraulic rods 2-5 provides upward pressure for the hydraulic power generation devices 2-2 to generate power; and when the internal tension of the mooring cable 4 disappears, the return springs 2-6 drive the hydraulic rods 2-5 on the connecting plate 2-4 of the second power generation device 2 to return to their respective initial positions. The second power generation device 2 continuously generates power through the tension on the mooring cables 4 and reset of the hydraulic power generation devices when the tension disappears.

The present disclosure enables the offshore platform to operate stably under shallow water conditions through the cooperation of the first power generation devices, the second power generation device, the anchors, the mooring cables and the anchor chains; further, the mooring tension is utilized, and the first power generation device and the second power generation device are used for power generation, such that marine energy is effectively utilized; the flexible retractable mooring cable is adopted to effectively avoid breakage due to impact loads generated from the mooring cable, the service life of the mooring system is prolonged, and the system safety is guaranteed; and the second power generation device is not only used for power generation, but also plays a role similar to an anchor, such that the stability of the offshore platform is further improved.

What is claimed is:

1. A flexible retractable mooring system suitable for medium and shallow water operation, comprising:
first power generation devices, a second power generation device, and anchors; wherein the first power generation devices and the second power generation device are all connected to an offshore platform through mooring cables, and the first power generation devices are further connected to the anchors through anchor chains; the second power generation device is located directly below the offshore platform, and the anchors are located obliquely below the offshore platform to fix the flexible retractable mooring system; and when the flexible retractable mooring system is operating, the mooring cables and the anchor chains are all in a tension state, and the first power generation devices and the second power generation device generate power by making use of tension of the mooring cables and the anchor chains.

2. The flexible retractable mooring system suitable for medium and shallow water operation according to claim 1, wherein the first power generation devices each comprises a housing, a rotating shaft located inside the housing, and a first reset mechanism; the first reset mechanism is mounted on a top of the housing, a roller for winding round one mooring cable is disposed below the first reset mechanism, a magnet is disposed below the roller, and coils are disposed at outer sides of the magnet; the first reset mechanism, the roller, and the magnet are all fixedly connected to the rotating shaft; internal tension of the mooring cable pulls the roller to rotate, the rotating shaft, the first reset mechanism and the magnet are then driven to rotate, a magnetic field around the magnet accordingly changes, and the coils cut magnetic induction lines to generate power; and when the internal tension of the mooring cable disappears, the first reset mechanism drives the first power generation devices to return to their respective initial positions.

3. The flexible retractable mooring system suitable for medium and shallow water operation according to claim 2, wherein an interior of the first power generation device is divided into an upper cavity and a lower cavity through a partition plate, the first reset mechanism and the roller are mounted inside the upper cavity, the magnet and the coils are mounted inside the lower cavity, and the rotating shaft passes through the partition plate and is mounted on an axis of one first power generation device.

4. The flexible retractable mooring system suitable for medium and shallow water operation according to claim 3, wherein the first reset mechanism comprises a volute spring, and a driven shaft located at a center of the volute spring; the driven shaft is fixedly connected to the rotating shaft; and a connecting member is disposed at an outer ring port of the volute spring, and the volute spring is mounted on the top of the housing through the connecting member.

5. The flexible retractable mooring system suitable for medium and shallow water operation according to claim 4, wherein the connecting member, the volute spring and the housing are all in welding connection.

6. The flexible retractable mooring system suitable for medium and shallow water operation according to claim 1, wherein the mooring cables are made from flexible material.

7. The flexible retractable mooring system suitable for medium and shallow water operation according to claim 2, wherein an opening through which the mooring cable passes, and a first shackle for connecting one anchor chain, are formed on an outer wall of the housing.

8. The flexible retractable mooring system suitable for medium and shallow water operation according to claim 1, wherein the second power generation device comprises a base, a second reset mechanism mounted on the base, a connecting plate connected to the second reset mechanism, a main shaft rod and hydraulic rods mounted on the connecting plate, and hydraulic power generation devices are disposed on the hydraulic rods; the main shaft rod is connected to the mooring cable, when the tension of the mooring cable pulls the main shaft rod to move upwards, the main shaft rod drives the connecting plate and the hydraulic rods to move upwards, the hydraulic rods provide upward pressure for the hydraulic power generation devices to generate power; and when the tension of the mooring cable disappears, the second reset mechanism drives the second power generation device to return to its initial position.

9. The flexible retractable mooring system suitable for medium and shallow water operation according to claim 8, wherein the second reset mechanism comprises a plurality of return springs.

10. The flexible retractable mooring system suitable for medium and shallow water operation according to claim 8, wherein a second shackle for being connected to the mooring cable is disposed on a top of the main shaft rod.
